(19) United States
(12) Patent Application Publication
(10) Pub. No.: US 2026/0328242 A1
(43) Pub. Date: Oct. 22, 2026

(54) Device for clipping a carabiner to an attachment point

(71) Applicant: Steven Phillips, Boulder, CO (US)

(72) Inventor: Steven Phillips, Boulder, CO (US)

(21) Appl. No.: 19/185,306

(22) Filed: Apr. 22, 2025

(51) Int. Cl. F16B 45/02

(52) U.S. Cl. CPC F16B 45/021; F16B 45/023

(57) ABSTRACT

A device for remotely clipping a wire-gate carabiner to an attachment point on a climbing route. The device comprises a rigid body that partially wraps around the spine of the carabiner, a prong that inserts into the space between the arms of the carabiner's wire gate to maintain it in an open position, and an attachment interface for mounting the device on a pole. The device is held in place by the spring tension of the wire gate and by gravity, allowing the carabiner to be lifted and clipped into an anchor. Upon release, the prong disengages, allowing the gate to close. The device has no moving parts, is compatible with various wire-gate carabiners, and facilitates fast, reliable clipping with minimal complexity.

### FIELD

The present invention relates to climbing equipment and, more specifically, to devices for remotely attaching carabiners to climbing anchors or attachment points using a pole-mounted tool.

### BACKGROUND

In climbing, particularly in sport climbing or route setting, climbers frequently need to clip a carabiner into a bolt hanger or similar attachment point located out of arm's reach. This is commonly done using a “stick clip”-a pole-mounted device that allows a carabiner to be positioned and attached to an anchor from the ground or from a lower position.

Existing devices for this purpose include models such as the Metolius Superclip, Trango Beta Stick Evo, Trango Squid, and HangDog Climbing's Magic Wand. While these tools perform the task, they present various limitations. For example, the Magic Wand is only compatible with specialized carabiners such as the Mad Rock Trigger Wire that can hold themselves open. The Metolius and Trango devices employ more complex mechanisms involving plastic articulated parts, springy wire arms, or movable components to hold carabiner gates open. These designs are typically larger, heavier, and more mechanically complex, making them harder to carry and use and more prone to breakage or failure. They may also resist disengaging smoothly once the carabiner is hanging from the bolt, due to the constant pressure applied to hold the gate open.

There is a need for a simpler, smaller, and more reliable device that securely holds a carabiner open and then releases it easily once the carabiner is clipped to an anchor.

### SUMMARY

The present invention provides a device for clipping a carabiner to an attachment point on a climbing route, designed specifically for use with carabiners that have a wire gate. The device consists of a rigid, single-piece body that interacts mechanically with the wire gate to hold the gate open and maintain the carabiner in position until clipping is complete.

The device comprises three functional features:
1. A body that wraps partially around the spine of the carabiner.
2. A prong that inserts up into the space between the two arms of the carabiner's wire gate, maintaining the gate in an open position.
3. An attachment interface for securing the device to a pole or stick, such as a threaded hole or clamping mechanism.

The tension of the wire gate itself acts to hold the prong in position and press the body against the spine of the carabiner. When the carabiner is lifted by the device and positioned on a bolt hanger or similar anchor, lowering the pole causes the prong to disengage from the wire gate, allowing the gate to snap shut.

This design is minimal, lightweight, and devoid of moving parts, resulting in improved durability, reliability, and ease of use compared to existing solutions.

### BRIEF DESCRIPTION OF THE DRAWINGS

FIG. 1 is an isometric view of the device from the left side, illustrating the overall geometry including the body (10), prong (12), and pole interface (14).

FIG. 2 is an isometric view of the device from the right side, showing the opposite face of the device and the positioning of the prong (12) relative to the body (10) and pole interface (14).

FIG. 3 is a side view of the device from the left, highlighting the profile of the prong (12) projecting from the body (10).

FIG. 4 is a top view of the device, showing the layout of the prong (12), body (10), and pole interface (14) from above.

FIG. 5 is an example view showing the device in use, with the prong (12) inserted up into the space between the two arms of a wire gate (18) of a carabiner (16), and the body (10) partially wrapped around the spine of the carabiner (22), with the device attached to a telescoping pole (20).

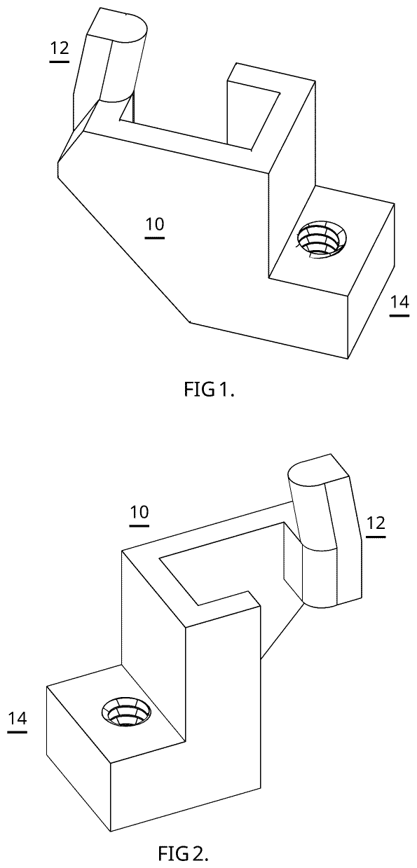

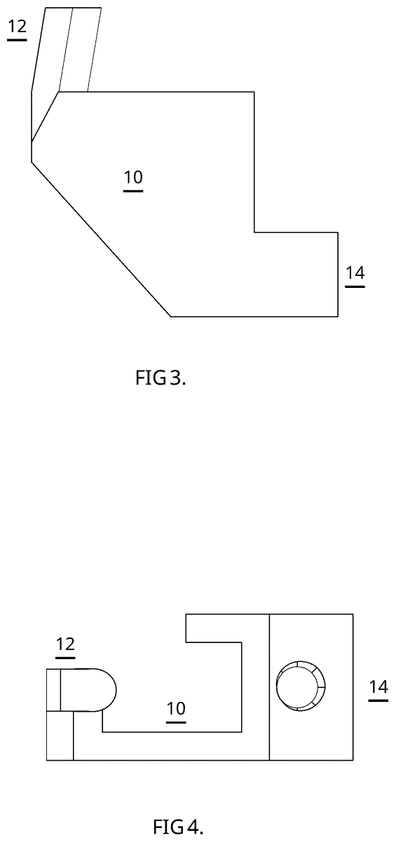

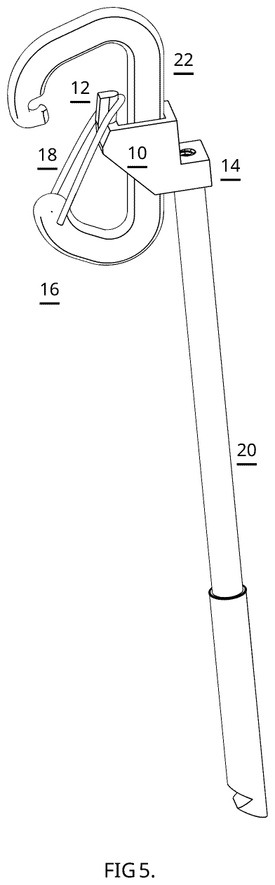

### DETAILED DESCRIPTION

The invention consists of a single, rigid body made from any suitable resilient and rigid material, such as aluminum or 3D-printed plastic. It includes three functional regions:
1. The Body
   This portion of the device is shaped to partially wrap around the spine of a wire-gate carabiner. It allows the device to be slid on and off the carabiner spine manually.
2. The Prong
   Projecting from the body, the prong is positioned and shaped such that when the body is in place on the spine of a carabiner, the prong can slide up into the space between the two arms of the wire gate. This insertion is only possible when the gate is fully open.
   Once inserted, the natural spring tension of the gate pushes against the prong, thereby pressing the body of the device against the carabiner's spine and holding the device in place.
   Gravity or any downward force (e.g., from a rope attached to the carabiner) further enhances the holding effect, as it increases the gate tension on the prong.
3. The Attachment Interface
   This portion allows the device to be mounted on a stick or pole. It may take the form of a ¼-20 threaded hole compatible with selfie stick mounts, a ¾-5 ACME threaded hole for painter's poles, or other mechanical fastening methods including clamps or straps.

The device is only compatible with carabiners that feature a wire gate design, as it requires the flexible, springy wire to hold the prong in place and uses the space between the two arms of the wire for prong insertion.

### Example Use Case

A climber attaches the device to a pole using the built-in interface. A wire-gate carabiner is selected and the device's body is slid onto its spine. The climber opens the wire gate fully and inserts the prong of the device up into the space between the two arms of the wire gate. The carabiner is now securely held in an open position, ready to clip. Using the pole, the climber lifts the carabiner to an anchor point, such as a bolt hanger. Upon positioning the carabiner on the anchor, the climber lowers the pole slightly. This releases tension on the gate, allowing the prong to disengage and the gate to snap shut. The carabiner remains clipped in place while the device is easily withdrawn by sliding it off the spine of the carabiner with a simple lowering and turning motion.

This process is fast, efficient, and requires no moving parts or complex mechanisms.

1. A device for clipping a wire-gate carabiner to an attachment point on a climbing route, the device comprising:
a. a rigid body shaped to partially wrap around the spine of a wire-gate carabiner;
b. a prong extending from the body, shaped and positioned to insert into the space between the two opposing arms of the carabiner's wire gate when the gate is fully open and the body is partially wrapped around the carabiner's spine;
c. an attachment interface for securing the device to an elongate pole.

2. The device of claim 1, wherein the body is configured to slide on and off the carabiner spine without tools.

3. The device of claim 1, wherein the attachment interface comprises a threaded hole.

4. The device of claim 3, wherein the threaded hole is a ¼-20 thread compatible with standard camera mounts or selfie sticks.

5. The device of claim 3, wherein the threaded hole is a ¾-5 ACME thread compatible with standard painter's poles.

6. The device of claim 1, wherein the attachment interface comprises a clamp or strap mechanism.

7. The device of claim 1, wherein the prong is shaped to disengage from the wire gate upon reduction of upward force applied to the device.

8. The device of claim 1, wherein the prong and body are dimensioned to maintain the carabiner in an open configuration until released when the carabiner is positioned on the attachment point and the device is lowered slightly.

9. The device of claim 1, wherein the device consists of a single rigid piece with no moving parts.
